(19) United States
(12) Patent Application Publication
(10) Pub. No.: US 2009/0180467 A1
(43) Pub. Date: Jul. 16, 2009

(54) System and Method for Connecting Remote Callers with PBX Extensions Using Internet Telephony

(76) Inventor: James Scott Storey, Berkeley, CA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/114,590

(22) Filed: May 2, 2008

Related U.S. Application Data
(60) Provisional application No. 61/011,398, filed on Jan. 16, 2008.

(51) Int. Cl. H04L 12/66

(52) U.S. Cl. 370/352

(57) ABSTRACT

A telecommunications system configured to provide access to a company's directory via a simple-to-use client software program; to integrate directory access with Internet telephony call establishment (click to dial); to automate the dialing of DTMF tones to connect to a specific extension; and to provide searching of the company's directory.

### CROSS REFERENCE TO RELATED APPLICATIONS

This application claims priority from Provisional Application No. 61/011,398, filed Jan. 16, 2008, which is hereby incorporated by reference in its entirety as if fully set forth herein.

### BACKGROUND OF THE INVENTION

1. Field of the Invention

This invention relates to telecommunications systems. More particularly, this invention relates generally to user interaction with a client computer program for the purpose of searching a directory and connecting to a PBX extension via the Internet.

2. Description of the Related Art

Private Branch Exchange (PBX) systems have been in common use for decades. PBX systems are telephone exchanges used by enterprises such as businesses to make internal connections among their telephony endpoint devices as well as to link to the public switched telephone network (PSTN). Telephony endpoint devices include, for example, telephones, facsimile machines, and the like. Endpoints may generally be referred to as “extensions.”

Historically, PBX systems have used circuit-switched technology to make the connections. Recent advances incorporate Internet Protocol (IP) to allow the PBX to communicate via lower cost Internet connections. SIP (Session Initiation Protocol) provides a simple signaling mechanism for controlling connections to an IP-PBX.

Peer-to-peer Internet telephony such as Skype™ allows voice communications between client computers such as a Personal Computer (PC) running Microsoft Windows or Linux operating systems. Certain peer-to-peer Internet telephony solutions allow program application extension via third party applications. Applications such as the Tumara™ PBX by Sandhills Software provide a virtual PBX, where a single Skype™ address can be redirected to other Skype users or to Public (PSTN) telephone numbers.

However, connecting a user of a peer-to-peer Internet telephone service directly to a PBX extension has been problematic.

### SUMMARY OF THE INVENTION

According to specific embodiments, some of the objects and advantages of this invention are to provide access to a company's directory via a simple-to-use client software program; to integrate directory access with Internet telephony call establishment (click to dial); to automate the dialing of DTMF tones to connect to a specific extension; and to provide searching of the company's directory.

According to specific embodiments, this invention includes systems, methods, and computer program products for presenting directory information to users using a personal computer application that accesses a server application using Internet telephony protocols. Described embodiments further allow for establishing an Internet telephony connection to a selected remote extension. Described embodiments also allow for directory searching for a specific user name or pattern of user names.

In operation, according to some embodiments, a user can interact with a personal computer application, which is connected via a public Internet telephony service such as Skype™. A server application connects to the Internet telephony service with an Internet telephony service user name, which has been previously registered with the Internet telephony service. For example, the username may be the name of the company, registered as a Skype™ user. The personal computer application utilizes an application extension capability of the Internet telephony service to initiate a connection to the server. The personal computer application sends a command message via the application extension capability to the server. The server accesses the company directory using any of a number of possible directory service mechanisms. The server converts the directory to a format that can be transported via the Internet telephony application extension, for example, as a stream of delimited ASCII text. The personal computer application receives the directory information and displays this to the user.

According to some embodiments, the user selects a specific entry from the displayed directory information, and directs the personal computer application to dial the selected entry. The personal computer application sends a command to the Internet telephony service to call the company's user name. The Internet telephony service connects to the designated user name. Some embodiments work in conjunction with a software bridge, which connects the Internet telephony service to a PBX. Once the Internet telephony call is connected, it is bridged to the PBX auto-attendant. The personal computer application then sends a sequence of DTMF tones to instruct the PBX to connect the call to the desired extension.

In some embodiments, a user may search for a user name based on a pattern. For example, the user may search for all last names starting, e.g., with “Sm”. The personal computer application sends a search command message along with a parameter for the search pattern via the application extension capability to the server. The server accesses the company directory using any of a number of possible directory service mechanisms, and filters the entries to those that match the search pattern. The server converts the directory to a format that can be transported via the Internet telephony application extension, for example, as a stream of delimited ASCII text. The personal computer application receives the directory information and displays this to the user.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 illustrates an exemplary system according to embodiments of the present invention.

FIG. 2 illustrates an exemplary graphical user interface according to embodiments of the present invention.

FIG. 3 is a flowchart illustrating operation of an embodiment of the present invention.

FIG. 4 illustrates an exemplary system according to embodiments of the present invention.

FIG. 5 illustrates an exemplary graphical user interface according to embodiments of the present invention.

FIG. 6 is a flowchart illustrating operation of an embodiment of the present invention.

FIG. 7 illustrates an exemplary system according to embodiments of the present invention.

FIG. 8 illustrates an exemplary graphical user interface according to embodiments of the present invention.

FIG. 9 is a flowchart illustrating operation of an embodiment of the present invention.

FIG. 10 is a diagram of an exemplary device in accordance with embodiments of the present invention.

### DETAILED DESCRIPTION OF EMBODIMENTS OF THE INVENTION

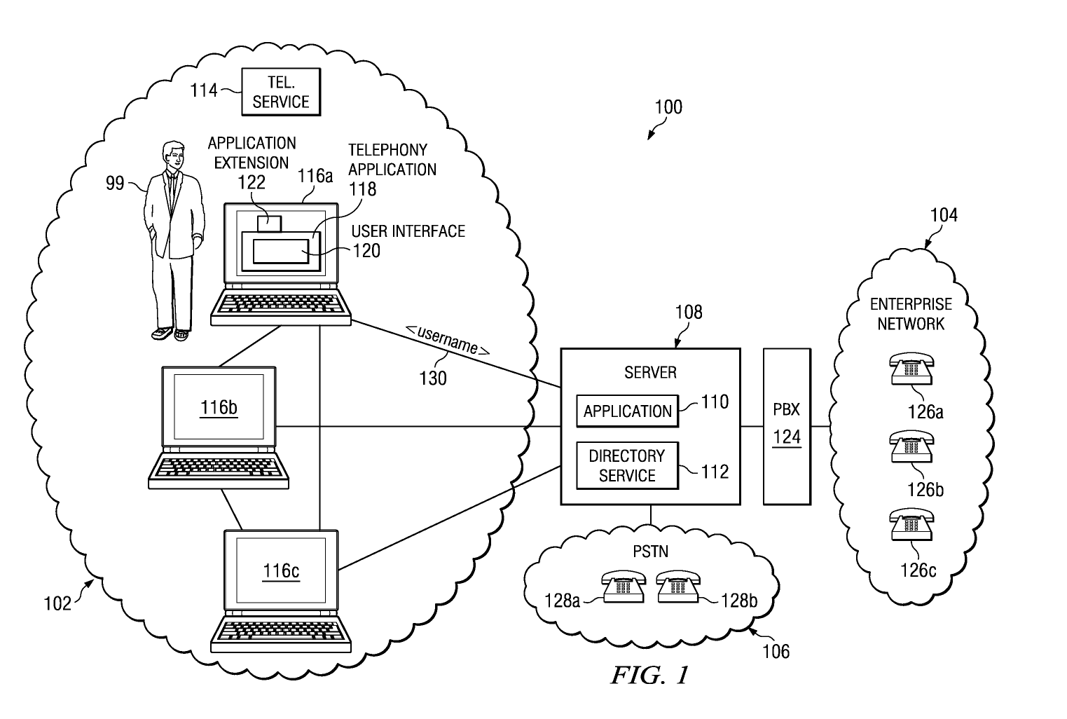

Turning now to the drawings and, with particular attention to FIG. 1, a diagram of a telecommunications system 100 according to an embodiment of the present invention is shown.

The telecommunications system 100 includes a packet telephone network 102, such as an Internet telephone network; and an enterprise or company network 104; and may also include or be in communication with a public telephone network 106, such as the PSTN (public switched telephone network), which may include one or more wired or wireless networks.

The Internet telephony network 102 includes a plurality of network clients or user devices, such as personal computers 116a, 116b, 116c. For example, user devices 116a, 116b, 116c may be embodied as personal computers implementing the Windows XP or Vista operating system with an Internet access program, such as via a web browser, such as the Microsoft Explorer or Mozilla Firefox web browser. The Internet telephony network 102 is operable to provide a packet-switched telephone service over the Internet. An exemplary Internet telephony service is the Skype™ service, although other services are contemplated. It is noted that other network clients, such as standalone Internet telephones, PDAs, PocketPCs, computers, etc., are contemplated. For sake of simplicity, discussion herein will focus on network clients implemented as personal computers.

As will be explained in greater detail below, and as shown with reference to personal computer 116a, the personal computers 116a, 116b, 116c may implement Internet telephony applications programs 118, user interfaces 120, and directory access applications 122, in accordance with embodiments of the present invention. In some embodiments, the directory access applications 122 may be implemented as API (application programming interface) extensions to the telephony application program 118. Thus, the directory access applications 122 may also be referred to as “access extensions” or “application extension APIs.”

The telecommunications system 100 includes a server 108 that implements a directory server application 110 and a directory service 112 in accordance with embodiments of the present invention. The server 108 may be implemented as a suitably modified Internet telephony server providing support for, for example, the Skype™ service. Alternatively, the server 1 08 may be a standalone server. In some embodiments, the system may include a separate server 114 that implements directory and address services for the Internet telephony network. In general, the various applications and services may be implemented in hardware and/or software operating on one or more servers, computer systems, host or mainframe computers, workstations, etc. In some embodiments, the Internet telephony network may further include one or more supernodes, etc. (not shown) and other Internet telephony service devices, etc.

In addition, the server 108 may couple to or be in communication with one or more private branch exchanges (PBX) 124. The PBX 124 may be embodied as a HiPath™ PBX available from Siemens Communications, Inc., and is configured to communicate with the server 108, as will be explained in greater detail below. The PBX 124 further couples to or is in communication with an enterprise network 104, providing exchange services for the enterprise's internal network 104, and supporting a plurality of telephony devices 126a, 126b, 126c, identified by corresponding extensions. The telephony devices 126a, 126b, 126c may be telephones, facsimile machines, computers with telephony applications, etc., and may further include wired or wireless devices. It is noted that typically, more than three devices may be provided. Thus, the figures are exemplary only.

In some embodiments, the network 104 may be a local area network implementing an IP telephony protocol. Thus, the network 104 may also include other hardware and/or software components (e.g., gateways, proxy servers, registration server, presence servers, redirect servers, databases, applications, etc.) such as, for example, hardware and software used to support a SIP (Session Initiation Protocol) or other protocol based infrastructure for the network 104 and allow the registration of SIP devices in the network 104.

In some embodiments, the networks 102, 104 can also include other public and/or private wide area networks, local area networks, wireless networks, data communications networks, or connections, intranets, routers, satellite links, microwave links, cellular or telephone networks, radio links, fiber optic transmission lines, ISDN lines, T1 lines, DSL connections, the public switched telephone network (PSTN), etc. Moreover, as used herein, communications include those enabled by wired or wireless technology.

As noted above, the system 100 may include or be in communication with a public telephone network 106, including a plurality of wired or wireless telephony devices 128a, 128b. Such devices may be embodied as, for example, conventional digital or analog telephones, as well as cellular telephones, PDAs, etc. Typically, telephony devices on the enterprise network 104 may communicate with the PSTN devices 128a, 128b and vice versa.

The directory access application extension 122 operates in conjunction with the Internet telephony application program 118 and the user interface 120 to display a company directory for the purpose of directly connecting to a specific PBX extension 126a-126c on the enterprise network 104 via the PBX 124.

In operation, a company, e.g., associated with enterprise network 104 and PBX 124, registers a “username” with an Internet telephony service. This may include, for example, registration with a central or distributed service, such as at server 114 (or server 108). The company provides this username to users 99 either by publishing the username in a public forum, e.g., on their corporate website (not shown), or by transmitting the username to selected users, e.g., via email or other correspondence.

The company may make use of one of the user devices 116a, 116b, 116c to communicate with the server application 110 (.e.g, via the Internet), which may be configured to run continuously. The server application 110 establishes a connection to the Internet telephony service, and associates the server 108 with the Internet telephony service username. Establishing the connection may include, for example, logging in or accessing a service such as Skype™.

Once registered, a party can connect to a company extension 126a-126c. Upon start-up of the personal computer application 118, the user indicates the company he wishes to communicate with, by entering the Internet telephony service username provided by that company. The personal computer application 118 establishes a connection to the Internet telephony service, using the directory application extension API 122. The personal computer application 118 requests an “application extension session” in accordance with embodiments of the present invention with the specified Internet telephony service username.

The Internet telephony service connects the personal computer application 118 to the server application 110 using standard or proprietary protocols. Once the connection is established, the server application 110 accesses a company directory 112; the directory itself may be implemented using one of many possible directory services. The directory information includes both a name (e.g., first name, last name) and an extension number. The server application 110 then sends the directory to the personal computer application 118 using a protocol that can be supported by the Internet telephony service application extension 122, for example, as an ASCII string with new-line delimiters to separate the records. The personal computer application 118 receives the directory information, and displays this to the user on the user interface 120.

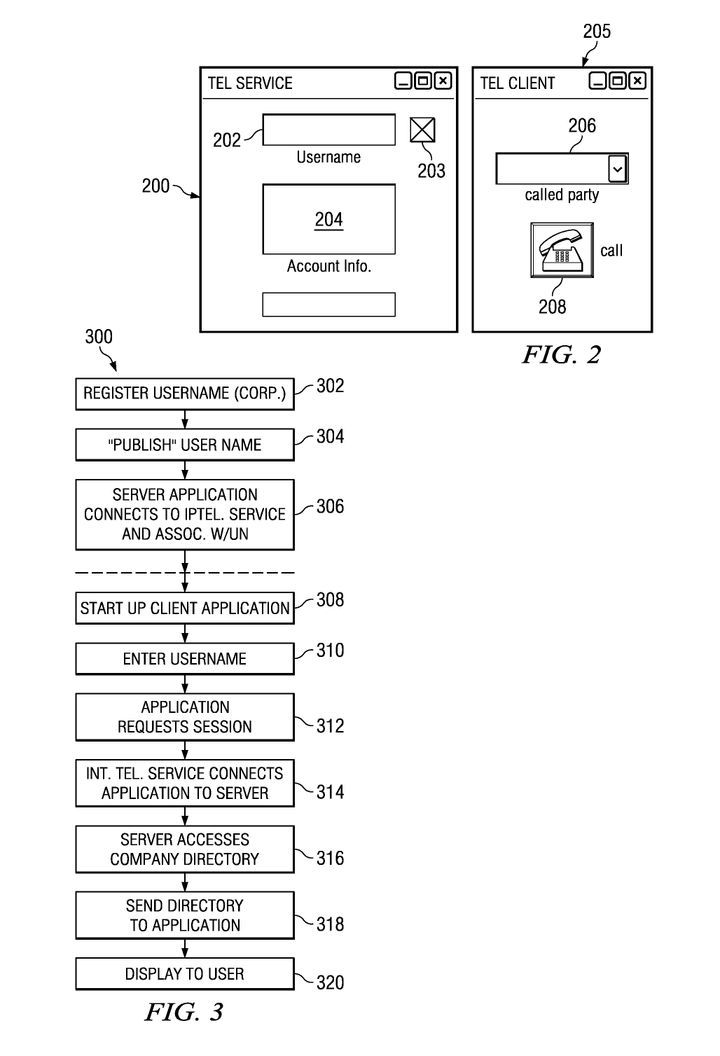

Turning now to FIG. 2, a diagram of an exemplary graphical user interface 200 that may be used in conjunction with embodiments of the present invention is shown. Shown is a window 200 that can be used to register with an Internet telephony service. For example, window 200 includes a user name entry window 202 and account information entry window 204. The company user 99 (FIG. 1) may enter his user name and account information in the corresponding fields, and upload them to the service. The service will then associate the user name with the account information.

Once the user name has been registered, a user can call an extension at the company user name, as will be discussed in greater detail below, using a window or interface such as shown at 205. In particular, window 205 includes a called party select control 206, which may be, for example, a dropdown window or other selection interface. The user can then select the call control 208 to call the party at the corresponding user name. If the user name corresponds to a company, the user will be able to request a directory session, as will be explained in greater detail below.

Turning now to FIG. 3, a flowchart 300 illustrating operation of an embodiment of the present invention is shown. The particular arrangement of elements in the flowchart 300 is not meant to imply a fixed order to the elements; embodiments can be practiced in any order that is practicable.

Initially, in a step 302, a user 99 can register a user name with an Internet telephony service 102, for example, via the server 108. The user name may be associated with a particular company or other enterprise. Thus, the registration would typically be by an IT staff member on behalf of other enterprise users. In a process step 304, the user name can then be published to or for the company users. For example, as noted above, this can include publishing the user name on a corporate web site, or can include distributing the user name via e-mail or other forms of electronic messaging. In a process step 306, the server application 110 can connect to the Internet telephony service to associate/register the user name with the particular company.

It is noted, as indicated by the dashed line, that the steps 302-306 may occur during a different session from those that follow. That is, a user need not re-register each time he uses a system implementing the invention

In a process step 308, a user 99 can start up his Internet telephony client 118 running on his personal computer 116. In a process step 310, the user 99 can select or enter the company user name into the graphical user interface 120. As discussed above, this can include the user selecting a name from a pulldown menu, etc. In a process step 312, in response, the application program 118 and, particularly, the directory extension 122, requests a directory session. The Internet telephony service connects to the server 108, in a process step 314. That is, the Internet telephony service causes an Internet telephony connection to be made to the server 108.

In a process step 316, the server 108's application 110 accesses the directory service 112. In a process step 318, the directory service 112 sends the directory to the user's application extension 122 and application 118. Finally, in a process step 320, the user interface 120 can display the directory.

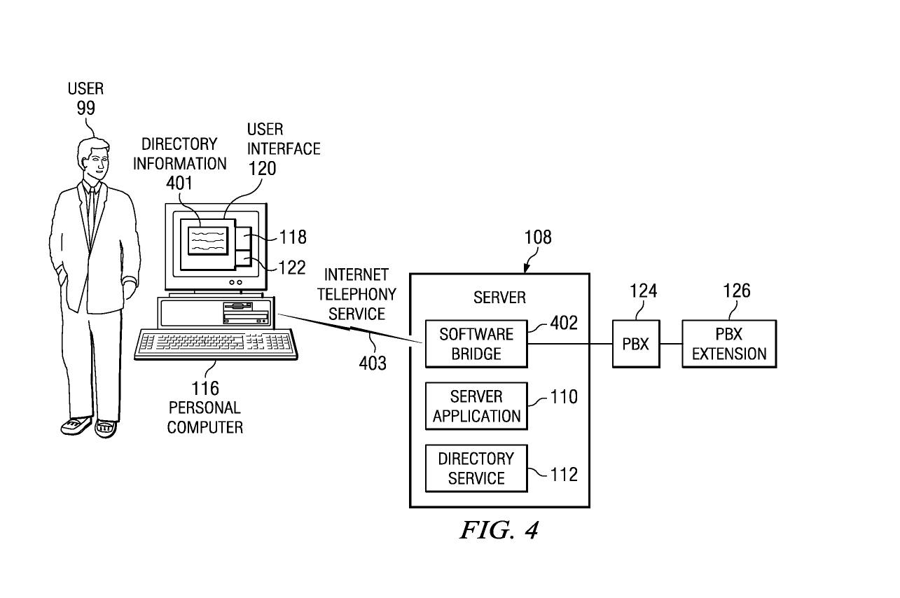

FIG. 4 shows in greater detail a general block diagram of the components of a solution provided by the invention where a phone call to a specific extension is established, according to a specific embodiment. That is, as will be explained in greater detail below, a call to a user name may be bridged to a specific extension.

Once the personal computer application 118 has received the directory information 401 for a specific remote user (as discussed above), it can be displayed using the interface 120 and the user can request the personal computer application 118 (and extension API 122) to connect an Internet telephony call to the corresponding PBX extension 126a-126c. The personal computer application 118 requests the Internet telephony service (represented by numeral 403) to initiate a call to the corresponding Internet telephony service username for the company. The Internet telephony service 403 can send a message to the application 118 indicating that the call is connected. When the call is connected, bridge software 402, such as commercial bridge software, connects the Internet telephony call to the company PBX 124. The personal computer application 118 then requests the Internet telephony service to send a sequence of DTMF tones, corresponding to the sequence required by the PBX 124 to connect to the desired extension (For example, the DTMF tones for the extension number followed by the DTMF tone for the pound sign (#)). The PBX 124 may then initiate, for example, a SIP session with the remote user at the extension. Once the call is connected, the user can then communicate with the remote user (at the extension) using the standard Internet telephony service capabilities.

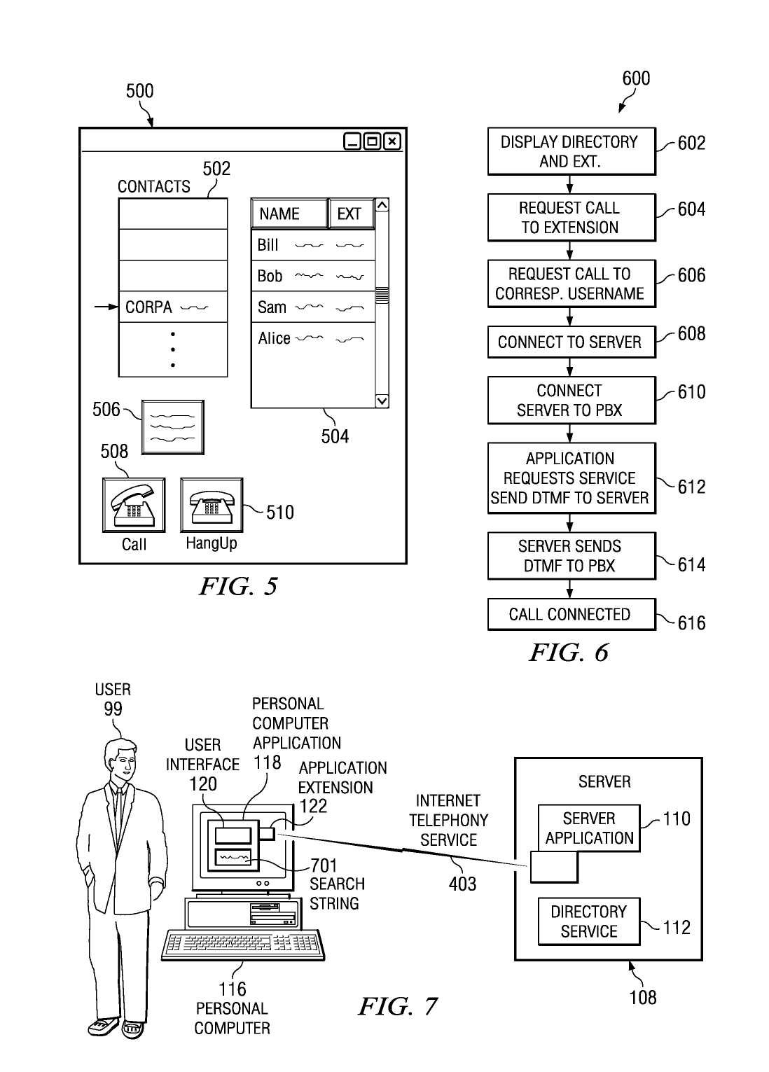

FIG. 5 is an exemplary user interface 500 that may be used to receive a directory and select an extension. Interface 500 includes a contacts window 502 and a directory window 504, as well as directory control 506, call control 508, and hang up control 510. In operation, a user can open window 500 and select control 506 to contact the server and receive the directory, as discussed above. The received directory can be displayed in window 504. The user can then highlight or otherwise select the corresponding entry and select dial 508 to dial the corresponding party.

Turning now to FIG. 6, a flowchart 600 illustrating operation of an embodiment of the present invention is shown. The particular arrangement of elements in the flowchart 600 is not meant to imply a fixed order to the elements; embodiments can be practiced in any order that is practicable.

In a process step 602, the graphical user interface 120 displays the downloaded directory information 401. As noted above, this can include displaying the directory in an interface such as that of FIG. 5. In a process step 604, the user 99 can request a call to the desired extension. For example, the user 99 can select the appropriate entry in the directory.

In response, in a process step 606, the Internet telephony application 118 requests a call to the user name corresponding to the selected entry. In a process step 608, the Internet telephony service 102 will connect the user to the server 108. In a process step 610, the server application 110 will identify the appropriate company and PBX corresponding to the user name and the bridge will connect the server 108 to the PBX 124. In a process step 612, the application 118 may request that the telephony service sends the appropriate DTMF tones to the server 108. In a process step 614, the server 108 sends the DTMF tones to the PBX 124. Finally, in a process step 616, the call is connected to the corresponding extension; for example, the PBX can open a SIP session to the extension.

FIG. 7 shows a in greater detail a general block diagram where a personal computer application uses application extensions to an Internet telephony service to search a company directory, according to a specific embodiment.

In operation, a user can register a company username and call in to access the directory, in a manner similar to that discussed above. However, rather than requesting a directory listing, in some embodiments, the user can enter a string 701 containing a portion of the desired directory name, and directives for searching. For example, the user can enter a letter and request all the directory entries with a first name starting with that letter. Alternatively, the user could enter a string of characters and request all entries corresponding to or matching the string.

The personal computer application 118 transmits the portion of the name (i.e., the string) and the directives to the server application 110 via the Internet telephony service application extension 122. The server application 110 searches the directory 112 for any matching entries. The server application 110 then sends the matching entries to the personal computer application 118 using a protocol that can be supported by the Internet telephony service application extension 122. The personal computer application 118 receives the matching entries, and displays them to the user using the user interface 120. The user can then call the extension, in a manner similar to that discussed above.

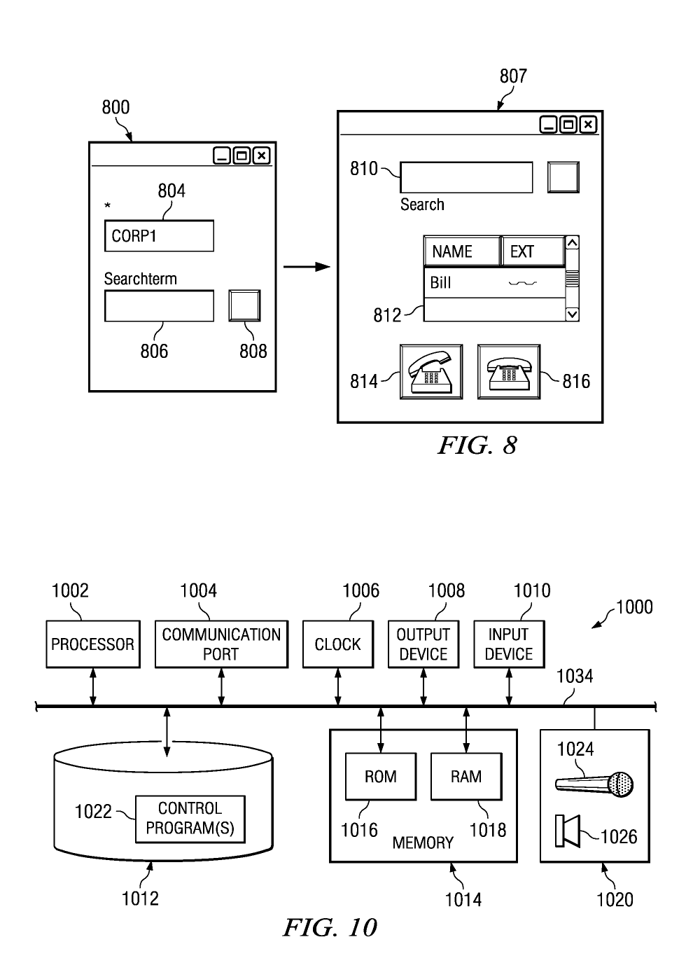

FIG. 8 is a diagram illustrating an exemplary graphical user interface that may be used to search a directory in accordance with embodiments of the present invention. Shown at 800 is a window including a username listing 804 (which may, for example, be a dropdown menu or other listing) and a search term entry field 806. In operation, the user can select a called party user name from the drop down menu 804. He can then enter a search term in field 806. By selecting the send control 808 he can call the server and send the search term. It is noted that, in some embodiments, more than one search term may be used or sent. For example, Boolean operators may be supported. Furthermore, in some embodiments, more than one field may be provided. In addition, it is noted that the search term (or terms) can include one or more letters or other characters including, for example, wildcards. Thus, the figure is exemplary only.

Once the user has made the selection and transmitted his request, the results may be returned in an interface similar to that shown at 807. In particular, shown is a search field 810 (for further searching, for example), a results window 812 showing the returned entries and associated extensions, and call and hangup buttons 814, 816, which permit the user to call the selected or returned entries. Again, the user may select the entry from the results window 812 to call the corresponding party.

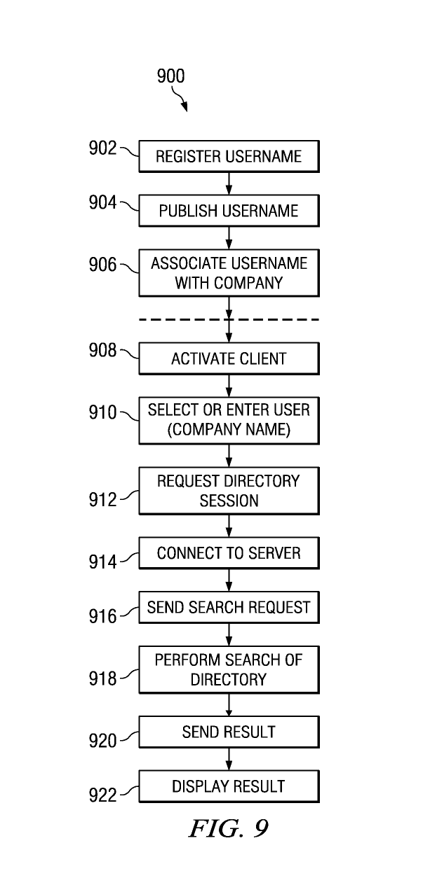

Turning now to FIG. 9, a flowchart 900 illustrating operation of an embodiment of the present invention is shown. The particular arrangement of elements in the flowchart 900 is not meant to imply a fixed order to the elements; embodiments can be practiced in any order that is practicable.

Initially, in a step 902, a user 99 can register a user name with an Internet telephony service, for example, via server 108. The user name may be associated with a particular company or other enterprise. Thus, the registration would typically be by an IT staff member on behalf of other enterprise users. In a process step 904, the user name can then be published to or for the company users. For example, as noted above, this can include publishing the user name on a corporate web site, or can include distributing the user name via e-mail or other forms of electronic messaging. In a process step 906, the server application 110 can connect to the Internet telephony service to associate the user name with the particular company.

It is noted, as indicated by the dashed line, that the steps 902-906 may occur during a different session from those that follow. That is, a user need not re-register each time he uses a system implementing the invention.

In a process step 908, a user 99 can start up his Internet telephony client 118 running on his personal computer. In a process step 910, the user 99 can select or enter the company user name into the graphical user interface. As discussed above, this can include the user selecting a name from a pulldown menu, etc. In addition, he can enter one or more search terms, as discussed above. In a process step 912, in response, the application program and, particularly, the extension 122, requests a directory session for a directory corresponding to the user name. The Internet telephony service 102 connects to the server 108, in a process step 914. That is, the Internet telephony service causes an Internet telephony connection to be made to the server 108.

In a process step 916, the search request is sent to the server. In response, in a process step 918, the server application 110 accesses the company directory 112 and performs the received search. In a process step 920, the application 110 sends the completed search to the client application 118. Finally, in a process step 922, the results, i.e., the matching entries, are received and displayed on interface 122. The user 99 can then call the party extension corresponding to a returned entry, in a manner similar to that discussed above.

Now referring to FIG. 10, a representative block diagram of an exemplary computer or processing device 1000 suitable for use as a user device or a server according to embodiments of the present invention is shown. In particular, the computer 1000 may be a device suitable for accessing or implementing a service or clients in accordance with embodiments of the present invention. In some embodiments, the computer 1000 may include or operate a web browser or telephony clients. The computer 1000 may be embodied as a single device or computer, a networked set or group of devices or computers, a workstation, mainframe or host computer, etc. In some embodiments, the computer 1000 may implement one or more elements of the methods disclosed herein.

The computer 1000 may include a processor, microchip, central processing unit, or computer 1002 that is in communication with or otherwise uses or includes one or more communication ports or network interfaces 1004 for communicating with user devices and/or other devices. The communication ports 1004 may include such things as telephone adapters, local area network adapters, wireless communication devices, Bluetooth technology, etc. The computer 1000 also may include an internal clock element 1006 to maintain an accurate time and date for the computer 1000, create time stamps for communications received or sent by the computer 1000, etc.

If desired, the computer 1000 may include one or more output devices 1008 such as a printer, infrared or other transmitter, antenna, display screen or monitor, text to speech converter, speaker, etc., as well as one or more input devices 1010 such as a bar code reader or other optical scanner, infrared or other receiver, antenna, magnetic stripe reader, image scanner, roller ball, touch pad, joystick, touch screen, computer keyboard, computer mouse, microphone, etc. In some embodiments, the computer 1000 may include a telephony interface 1020 including, for example, a microphone 1024 and speaker 1026.

In addition to the above, the computer 1000 may include a memory or data storage device 1012 to store information, software, databases, documents, communications, device drivers, etc. The memory or data storage device 1012 may be implemented as an appropriate combination of magnetic, optical and/or semiconductor memory, and may include, for example, Read-Only Memory (ROM), Random Access Memory (RAM), a tape drive, flash memory, a floppy disk drive, a Zip™ disk drive, an optical disk such as a compact disc or DVD and/or a hard disk. Thus, the storage device 1012 may include various combinations of moveable and fixed storage. The computer 1000 also may include memory 1014, such as ROM 1016 and RAM 1008.

The processor 1002 and the data storage device 1012 in the computer 1000 each may be, for example: (i) located entirely within a single computer or other computing device; or (ii) connected to each other by a remote communication medium, such as a serial port cable, telephone line or radio frequency transceiver. In one embodiment, the computer 1000 may be implemented as one or more computers that are connected to a remote server computer, as will be explained in greater detail below.

A conventional personal computer or workstation with sufficient memory and processing capability may be used as the computer 1000. The computer 1000 may be capable of high volume transaction processing, performing a significant number of mathematical calculations in processing communications and database searches. A microprocessor such as a processor manufactured by Intel Corporation may be used for the processor 1002. Other suitable processors may be available from AMD, or Sun Microsystems, Inc., and other manufacturers The processor 1002 also may be embodied as one or more microprocessors, computers, computer systems, etc.

Software may be resident and operating or operational on the computer 1000. The software may be stored on the data storage device 1012 and may include one or more control programs 1022. The control programs 1022 may implement the various services and clients described herein.

It is noted that, while illustrated as software stored in storage medium 1012, the various control modules in accordance with embodiments of the present invention may also include related firmware and/or hardware components. Thus, the figure is exemplary only.

The control program 1022 may control the processor 1002. The processor 1002 may perform instructions of the control program 1022, and thereby operate in accordance with the methods described in detail herein. The control programs may be stored in a compressed, uncompiled and/or encrypted format. The control programs furthermore may include program elements that may be necessary, such as an operating system, a database management system and device drivers for allowing the processor 1002 to interface with peripheral devices, databases, etc. Appropriate program elements are known to those skilled in the art, and need not be described in detail herein.

According to some embodiments, the instructions of the control program may be read into a main memory from another computer-readable medium, such as from the ROM 1016 to the RAM 1008. Execution of sequences of the instructions in the control program causes the processor 1002 to perform the process elements described herein. In alternative embodiments, hard-wired circuitry may be used in place of, or in combination with, software instructions for implementation of some or all of the methods described herein. Thus, embodiments are not limited to any specific combination of hardware and software.

The processor 1002, communication ports 1004, clock 1006, output device 1008, input device 1010, data storage device 1012, ROM 1016 and RAM 1008 may communicate or be connected directly or indirectly in a variety of ways. For example, the processor 1002, communication ports 1004, clock 1006, output device 1008, input device 1010, data storage device 1012, ROM 1016 and RAM 1008 may be connected via a bus 1034.

While specific implementations and hardware/software configurations for the computer 1000 have been illustrated, it should be noted that other implementations and hardware configurations are possible and that no specific implementation or hardware/software configuration is needed. Thus, not all of the components illustrated in FIG. 10 may be needed for the computer 1000 implementing the methods disclosed herein.

As used herein, whether in the above description or the following claims, the terms “comprising,” “including,” “carrying,” “having,” “containing,” “involving,” and the like are to be understood to be open-ended, that is, to mean including but not limited to. Only the transitional phrases “consisting of” and “consisting essentially of,” respectively, shall be conside transitional phrases, as set forth, with respect to claims, in the United States Patent Office Manual of Patent Examining Procedures.

Any use of ordinal terms such as “first,” “second,” “third,” etc., in the claims to modify a claim element does not by itself connote any priority, precedence, or order of one claim element over another, or the temporal order in which acts of a method are performed. Rather, unless specifically stated otherwise, such ordinal terms are used merely as labels to distinguish one claim element having a certain name from another element having a same name (but for use of the ordinal term).

The above described embodiments are intended to illustrate the principles of the invention, but not to limit the scope of the invention. Various other embodiments and modifications to these preferred embodiments may be made by those skilled in the art without departing from the scope of the present invention.

What is claimed is:

1. A telecommunications system, comprising:
a plurality of user devices configured to make telephone calls using an Internet telephony service;
a communications service configured to connect an Internet telephony service telephone call from a user device to an enterprise private branch exchange (PBX) and transport an associated enterprise directory to the user device, the corporate directory defining a plurality of enterprise extensions associated with PBX user devices;
means for connecting the Internet telephony call to an associated extension selected from the enterprise directory.

2. A telecommunications service in accordance with claim 1, wherein the Internet telephony service telephone call from the user device is a call to an associated enterprise user name.

3. A telecommunications service in accordance with claim 1, wherein the user devices include an Internet telephony service software interface including an extension for reading the associated enterprise directory.

4. A telecommunications service in accordance with claim 3, wherein the extension is configured for database searching of the enterprise directory.

5. A telecommunications system in accordance with claim 1, wherein the connecting means includes means for generating appropriate dual tone multifrequency (DTMF) tones corresponding to the extension number.

6. A telecommunications method, comprising:
dialing an enterprise PBX using an enterprise user name over an Internet telephony telephone service from a calling party user device;
transmitting DTMF tones corresponding to a called party user device extension associated with the enterprise PBX; and
connecting the calling party user device to the called party user device.

7. A telecommunications method in accordance with claim 6, further comprising downloading to the calling party user device an enterprise directory responsive to connecting to the PBX over the Internet telephony telephone service.

8. A telecommunications method in accordance with claim 7, wherein the enterprise directory is user searchable according to predetermined criteria.

9. A telecommunications method in accordance with claim 8, wherein the predetermined criteria include a search string of one or more characters.

10. A telecommunications system in accordance with claim 6, further comprising downloading to a directory server the enterprise directory from the PBX.

11. A telecommunications system in accordance with claim 1 0, further including searching the directory at the directory server using one or more predetermined search strings transmitted from the calling party user device.

12. A telecommunications server, comprising:
an Internet telephony interface configured to receive Internet telephony telephone calls;
a PBX interface configured to interface to a PBX;
a bridge configured to interface a call received over the Internet telephony interface to the PBX interface and identify an extension supported by the PBX.

13. A telecommunications server in accordance with claim 12, further including a directory service configured to download a directory from the PBX.

14. A telecommunications server in accordance with claim 13, wherein the directory service is configured to transmit at least a portion of directory content to a calling party.

15. A telecommunications server in accordance with claim 14, wherein the at least a portion of directory content is searchable.

16. A telecommunications server in accordance with claim 14, wherein the directory is searchable at the server in accordance with search parameters input from the calling party.
